(19) United States
(12) Patent Application Publication
(10) Pub. No.: US 2023/0049900 A1
(43) Pub. Date: Feb. 16, 2023

(54) DISPLACED HAPTIC FEEDBACK

(71) Applicant: Toyota Research Institute, Inc., Los Altos, CA (US)

(72) Inventors: Hiroshi Yasuda, San Francisco, CA (US); Manuel Ludwig Kuehner, Mountain View, CA (US)

(21) Appl. No.: 17/403,219

(22) Filed: Aug. 16, 2021

(51) Int. Cl. G06F 3/01; G06F 3/0484; G06F 3/0488; G06K 9/00; B60W 50/00

(52) U.S. Cl. CPC G06F 3/016; G06F 3/017; G06F 3/04847; G06F 3/0488; G06K 9/00832; G06K 9/00355; B60W 50/0098; G06F 2203/014

(57) ABSTRACT

Displaced haptic feedback can be provided to a person providing an input on a user interface. The user interface can be operatively connected to a processor. The processor can be configured to receive an input signal from the user interface. Responsive to receiving the input signal, the processor can be further configured to cause a haptic device to be activated. The haptic device can be physically separated from the user interface. The haptic device can provides a haptic feedback to a user interacting with the user interface.

### FIELD

The present disclosure generally relates in general to user interfaces and, more particularly, to providing feedback to a user when interacting with a user interface.

### BACKGROUND

Vehicles often include various systems, such as infotainment systems and navigation systems. These systems are generally provided with a display around which mechanical control elements are arranged to provide a user interface mounted in a dashboard of a vehicle cabin for driver and front passenger access. Alternatively, the display combines at least some of the control elements into a touch panel display.

### SUMMARY

In one respect, arrangements described herein are directed to a displaced haptic feedback system. The system can include a user interface. The system can include a processor operatively connected to the user interface. The processor can be configured to receive an input signal from the user interface. The processor can be configured to output a signal to cause a haptic device to be activated in response to the input signal. The haptic device can be physically separated from the user interface. Thus, the haptic device can provide haptic feedback to a user interacting with the user interface.

In another respect, arrangements described herein are directed to a displaced haptic feedback method. The method can include receiving an input signal from a user interface. The method can also include causing a haptic device to be activated in response to receiving the input signal. The haptic device can be physically separated from the user interface. Thus, the haptic device can provide haptic feedback to a user interacting with the user interface.

### BRIEF DESCRIPTION OF THE DRAWINGS

FIG. 1 is an example of a vehicle with a displaced feedback system.

FIG. 2 is an example of a displaced haptic feedback method.

FIG. 3 is a first example of a displaced haptic feedback scenario.

FIG. 4 is a second example of a displaced haptic feedback scenario.

FIG. 5 is a third example of a displaced haptic feedback scenario.

FIG. 6 is a fourth example of a displaced haptic feedback scenario.

### DETAILED DESCRIPTION

In-vehicle touchscreens can cause a driver to focus his or her gaze on the touch screen to know whether the touch screen is being operated properly. This diversion of the driver's focus may increase driver distraction in comparison to traditional buttons and knobs which can be operated by feel. When a driver looks to a touchscreen, the driver's visual focus is necessarily taken away from the road. Such a change in visual focus, even for a few seconds, can compromise a driver's control of the vehicle. As a result, there is a diminished state of safety to the vehicle's occupants, the vehicle, and to individuals, property, and/or other vehicles in the vicinity of the vehicle.

Accordingly, arrangements described herein are directed to displaced haptic feedback. Arrangements described herein can, in response to receiving an input on a haptic device, cause a haptic device to be activated in response to the input signal. The haptic device can be physically separated from the user interface. Thus, the haptic device can provide displaced haptic feedback to a user interacting with the user interface.

Displaced haptic feedback can include a haptic output being provided in a location that is different than the location of a user's interaction (e.g., a fingertip) with a user interface. Displaced haptic feedback can include a haptic output being provided by a haptic device that will not be felt by the user on the same body part that provided the input on the input interface. Displaced haptic feedback can include a haptic output being provided by the haptic device(s) 140 so as to be felt by user on a portion of his or her body away from the point of contact between the user's body and the user interface. In some arrangements, displaced haptic feedback can include the haptic device and the input interface not being in the same field of view of the user (e.g., a driver). It will be appreciated that displaced haptic feedback can enable the user to not have to look at the user interface when an input is provided on it. Thus, the driver does not have to divert attention away from the road to understand that an input was successfully provided on the user interface.

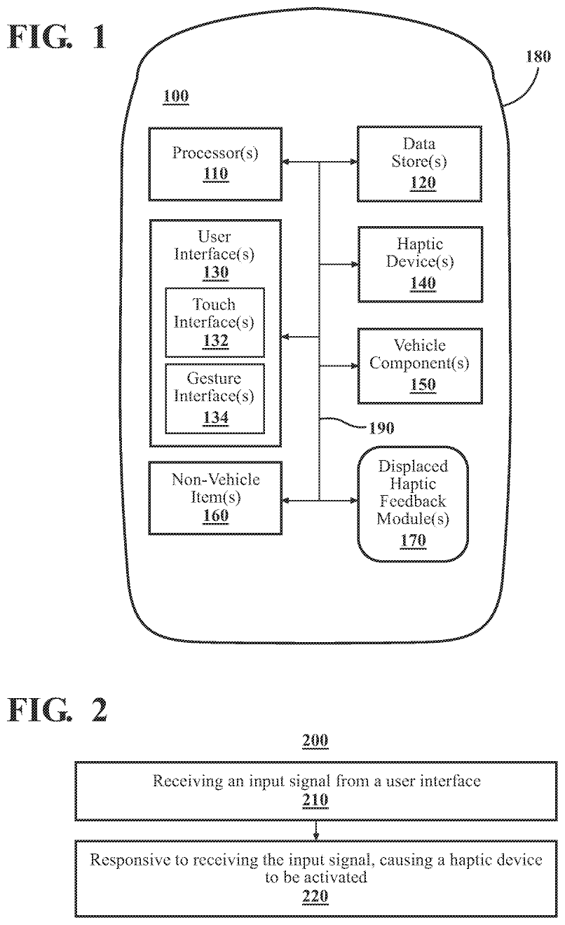

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example of at least a portion of a displaced haptic feedback system 100 is shown. Some of the possible elements of the displaced haptic feedback system 100 are shown in FIG. 1 and will now be described. It will be understood that it is not necessary for the displaced haptic feedback system 100 to have all of the elements shown in FIG. 1 or described herein. The displaced haptic feedback system 100 can have any combination of the various elements shown in FIG. 1. Further, the displaced haptic feedback system 100 can have additional elements to those shown in FIG. 1. In some arrangements, the displaced haptic feedback system 100 may not include one or more of the elements shown in FIG. 1. Further, the elements shown may be physically separated by large distances.

The displaced haptic feedback system 100 can include one or more processors 110, one or more data stores 120, one or more user interfaces 130, one or more haptic devices 140, one or more vehicle components 150, one or more non-vehicle items 160, and/or one or more displaced haptic feedback modules 170. In one or more arrangements, at least some of these various elements of the displaced haptic feedback system 100 can be located onboard a vehicle 180. In one or more arrangements, all of the various elements of the displaced haptic feedback system 100 can be located onboard the vehicle 180. As used herein, “vehicle” means any form of motorized or powered transport. In one or more implementations, the vehicle 180 can be an automobile, a land-based craft, a watercraft, an aircraft or any other form of motorized or powered transport. While arrangement will be described herein in connection with the vehicle 180, it will be appreciated that the displaced haptic feedback system 100 can be used in various non-vehicular applications.

Each of the above noted elements of the displaced haptic feedback system 100 will be described in turn below. The displaced haptic feedback system 100 can include one or more processors 110. “Processor” means any component or group of components that are configured to execute any of the processes described herein or any form of instructions to carry out such processes or cause such processes to be performed. The processor(s) 110 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 110 can include at least one hardware circuit (e.g., an integrated circuit) configured to carry out instructions contained in program code. In arrangements in which there is a plurality of processors 110, such processors can work independently from each other or one or more processors can work in combination with each other.

The displaced haptic feedback system 100 can include one or more data stores 120 for storing one or more types of data. The data store(s) 120 can include volatile and/or non-volatile memory. Examples of suitable data stores 120 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 120 can be a component of the processor(s) 110, or the data store(s) 120 can be operatively connected to the processor(s) 110 for use thereby. The term “operatively connected,” as used throughout this description, can include direct or indirect connections, including connections without direct physical contact.

The displaced haptic feedback system 100 can include one or more user interfaces 130. A user interface includes any device, component, system, element or arrangement or groups thereof that enable information, data, instructions, and/or commands to be entered into a machine and/or that enable information or data to be presented to a user. In some arrangements, the user interfaces(s) 130 can include one or more input interface(s) and/or one or more output interface(s).

An “input interface” includes any device, component, system, element or arrangement or groups thereof that enable information, data, instructions, and/or commands to be entered into a machine. The input interface(s) can be configured to receive an input from a user. The input interface(s) can include one or more user interface elements, including, for example, keypad(s), display(s), touch screen(s), multi-touch screen(s), button(s), switch(s), dial(s), joystick(s), a mouse/mice, trackball(s), microphone(s), gesture recognition (radar, lidar, camera, or ultrasound-based), and/or combinations thereof. In one or more arrangements, the input interface(s) can be configured to receive user inputs relating to the displaced haptic feedback system 100. In one or more arrangements, the input interface(s) can be configured to receive user inputs relating to the displaced haptic feedback system 100 as well as to other things.

The displaced haptic feedback system 100 can include one or more output interface(s). An “output interface” includes any device, component, system, element or arrangement or groups thereof that enable information or data to be presented to a user (e.g., a person, a vehicle occupant, etc.). Some components may serve as both a component of the input interface(s) and a component of the output interface(s). The output interface(s) can include display(s), speaker(s), projector(s), earphone(s), haptic device(s), and/or any of the items noted above in connection with the input interface(s), and/or combinations thereof.

In some arrangements, the user interface(s) 130 can include one or more touch interface(s) 132 and/or one or more gesture interface(s) 134. The touch interface(s) 132 can be any type of interface, now known or later developed, in which a user physically touches the interface to provide an input. Non-limiting examples of the touch interface(s) 132 can include touchscreen, a physical button, a virtual button, a graphical user interface element, a slider, a dial, a switch, a knob, or a joystick.

The gesture interface(s) 134 can be any type of interface, now known or later developed, in which a user provides an input by making a gesture with a part of the body (e.g., hand(s), arm(s), head, eyes, lips, etc.) without requiring physical contact with the interface. The gesture interface(s) 134 can include one or more cameras. For instance, the camera(s) can be positioned to receive input from the driver that provides a visual cue by a hand gesture, or even a facial expression or lip movement. The gesture interface(s) 134 can include any suitable gesture recognition software for analyzing acquired images or video to determine the intention of the gesture. Alternatively or additionally, the camera(s) can be positioned to detect the target of a finger pointed at a display, such as the display of a touchscreen, where the input does not require physical contact between the finger and the touchscreen.

In some arrangements, the user interface(s) 132 can be provided for controlling at least one of an environmental, entertainment, information component or feature of a vehicle. The user interface(s) 132 may be virtual buttons or sliders on touchscreens, finger gestures on touchscreens (e.g., pinch, swipe, etc.), physical buttons/sliders/volume knobs, or any other in-vehicle surfaces that can be associated to system functions (e.g., mirrors, levers, trim lights, door, windows, AC outlets, etc.). In some arrangements, cameras and/or projectors can be used to turn any surface in a vehicle into a touch surface with displaced haptic feedback in another area of the vehicle. For instance, a projector can be used to project buttons or other user interface elements of a vehicle surface.

The displaced haptic feedback system 100 can include one or more haptic devices 140. The haptic device(s) 140 can be any device that produces an output that is perceptible to the human sense of touch. For instance, the output of the haptic device(s) 140 can include vibration, pressure, heating and/or cooling sensations. In some arrangements, the haptic device(s) 140 can one or more haptic actuators. The one or more haptic actuators 136 can be operatively connected to one or more of the vehicle component(s) 150. The haptic actuators 136 can be any element or combination of elements configured to cause the vehicle component(s) 150 to provide a haptic indication responsive to receiving signals or other inputs from the processor 110 and/or other module or element of the displaced haptic feedback system 100. The processor 110 can be operatively connected to the haptic actuators. Any suitable actuator can be used. For instance, the one or more haptic actuators can include motors, pneumatic actuators, hydraulic pistons, relays, solenoids, and/or piezoelectric actuators, just to name a few possibilities. The haptic actuators can be used to provide haptic feedback in the form of vibration and/or pressure.

Alternatively or additionally, the haptic device(s) 140 can be configured to produce a heating or cooling sensation. To that end, the haptic device(s) 140 can include one or more cooling elements and/or one or more heating elements. Any suitable type of cooling elements and/or heating elements, now known or later developed, can be used. Non-limiting examples of cooling elements can include coolers, fans, blowers, air conditioners, etc. Non-limiting examples of heating elements can include heaters, electric heaters, heat coils, etc.

It should be noted that the haptic device(s) 140 can be configured to produce any suitable pattern for the haptic feedback. For example, when the haptic feedback is vibration, the vibration pattern may be a short vibration when the physical/virtual buttons are pressed. Alternatively, the vibration pattern can be a vibration with a ‘detent’ pattern when the volume or other button is rotated. The detent pattern can be based on the position/angle and moving/rotation direction and where the vibration has higher frequency/force when it's closer to the tick marks and no vibration when moving/rotating away from the tick marks.

The haptic device(s) 140 can be physically separated from the user interface(s) 130. “Physically separated” can include the haptic device(s) 140 not being located within the user interface(s) 130. “Physically separated” can include the haptic device(s) 140 and the user interface(s) 130 not being located within the same component. “Physically separated” can include the haptic device(s) 140 and the user interface(s) 130 being separated by a distance. In some instances, the distance can be large. In some arrangements, “physically separated” can include a minimum distance between the haptic device(s) 140 and the user interface(s) 130. In some arrangements, the minimum distance can be at least about 6 inches or more, at least about one foot or more, at least about two feet or more. In some arrangements, “physically separated” can include the haptic device(s) 140 and the user interface(s) 130 being positioned relative to each other so as not to be in the same field of view of the user (e.g., a driver). In some arrangements, “physically separated” can include the haptic device(s) 140 and the user interface(s) 130 being positioned relative to each other such that a user does not have to look at the user interface when an input is provided on it. In some arrangements, “Physically separated” can include the haptic device(s) 140 and the user interface(s) 130 being separated such that a haptic output provided by the haptic device(s) 140 will not be felt by the user on the same body part that provided the input on the user interface(s) 130. In some arrangements, “Physically separated” can include the haptic device(s) 140 and the user interface(s) 130 being separated such that a haptic output provided by the haptic device(s) 140 would be felt by user on a portion of his or her body away from the point of contact between the user's body and the user interface(s) 130.

The displaced haptic feedback system 100 can include one or more vehicle components 150. The vehicle component(s) 150 can be any component located on or within a vehicle. The vehicle component(s) 150 can be any component that a portion of a vehicle occupant's body comes into contact with, continuously or occasionally, while a person is inside the vehicle. Examples of the vehicle component(s) 150 can include a steering wheel, a seat, a seat back, an arm rest, a head rest, a footrest, or a pedal. In some arrangements, the haptic device(s) 140 can be located on and/or within a portion of the vehicle component(s) 150. In some arrangements, the haptic device(s) 140 can be located to provide haptic feedback to multiple users. As an example, the haptic device(s) 140 can be used in a row of seats. In such case, all users sitting in the row of seats can receive the haptic feedback.

The displaced haptic feedback system 100 can include one or more non-vehicle items 160. The non-vehicle item(s) 160 include items that are not a part of the vehicle 180. The non-vehicle item(s) 160 can be paired with the vehicle in such a way that the vehicle can cause the non-vehicle item(s) 160 to react in a particular way. In some instances, the non-vehicle item(s) 160 can be items that can be readily moved into and out of the vehicle 180. Examples of the non-vehicle item(s) 160 can include items worn, attached to, or carried by the user. In some arrangements, the non-vehicle item(s) 160 can include a watch, a bracelet, a necklace, jewelry, a headband, a belt, a hat, a pocket, a shirt, pants, clothing, or a wallet. In some arrangements, the non-vehicle item(s) 160 can include personal communication devices.

The displaced haptic feedback system 100 can include one or more modules. In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, the modules described herein can be combined into a single module.

The displaced haptic feedback system 100 can include one or more displaced haptic feedback modules 170. The displaced haptic feedback module 170 can be configured to receive an input signal from the user interface(s) 130. The input signal can, in and of itself, be an indication that an input was successfully received on the user interface(s) 130. Alternatively or additionally, the displaced haptic feedback module 170 can be configured to determine whether the input provided on the user interface(s) 130 was successful.

In response to response to receiving the input signal from the user interface(s) 130 (and/or determining that the input provided on the user interface(s) 130 was successful), the displaced haptic feedback module 170 can be configured to causing a haptic device to be activated. As used herein, “cause” or “causing” means to make, force, compel, direct, command, instruct, and/or enable an event or action to occur or at least be in a state where such event or action may occur, either in a direct or indirect manner. The displaced haptic feedback module 170 can be configured to execute various functions and/or to transmit data to, receive data from, interact with, and/or control the user interface(s) 130 and/or the haptic device(s) 140.

The various elements of the displaced haptic feedback system 100 can be communicatively linked to each other (or any combination thereof) through one or more communication networks 190. As used herein, the term “communicatively linked” can include direct or indirect connections through a communication channel or pathway or another component or system. A “communication network” means one or more components designed to transmit and/or receive information from one source to another. The data store(s) 120 and/or one or more of the elements of the displaced haptic feedback system 100 can include and/or execute suitable communication software, which enables the various elements to communicate with each other through the communication network and perform the functions disclosed herein.

The one or more communication networks 190 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The one or more communication networks 190 further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network(s) 190 can include wired communication links and/or wireless communication links. The communication network(s) 190 can include any combination of the above networks and/or other types of networks, now known or later developed.

Now that the various potential systems, devices, elements and/or components of a distracted driver notification system have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

Turning to FIG. 2, an example of a displaced haptic feedback method 200 is shown. At block 210, an input signal from a user interface (e.g., the user interface(s) 130) can be received. The input signal can be generated by the user interface(s) 130 when a user interacts with the user interface(s) 130, such as by a touch input, a gesture input, or by other input. The input signal can be sent to the processor(s) 110 and/or the displaced haptic feedback module(s) 170. The displaced haptic feedback method 200 can continue to block 220.

At block 220, in response to receiving the input signal from the user interface, a haptic device can be caused to be activated. The haptic device can be any of the haptic device(s) 140 described above. The causing can be performed by the displaced haptic feedback module 170 and/or the processor(s) 110. When activated, the haptic device(s) 140 can provide haptic feedback to a user providing an input on the user interface(s) 130. The haptic device can be physically separated from the user interface.

After block 220, the displaced haptic feedback method 200 can end. Alternatively, the displaced haptic feedback method 200 can return to block 210 or some other block. The displaced haptic feedback method 200 can be performed continuously, periodically, irregularly, randomly, or responsive to a condition, event, or input. The displaced haptic feedback method 200 can include additional and/or alternative steps to those describe above.

Non-limiting example of the above-described systems, methods and/or arrangements will be described in relation to various scenarios.

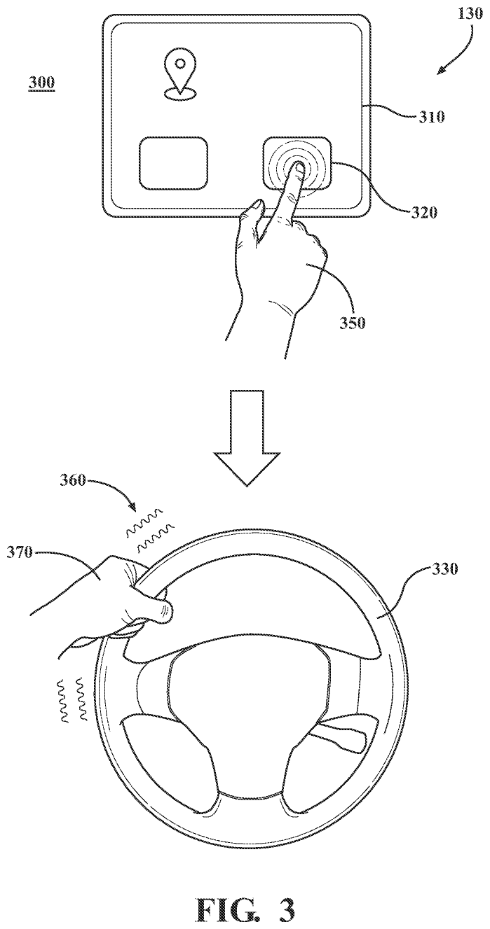

FIG. 3 is a first example of a displaced feedback scenario 300, which can be inside a vehicle cabin. Here, the user interface 130 can be a touchscreen 310 with a virtual button 320. In some cases, the touchscreen 310 can be located near the center of the vehicle's dashboard. The virtual button 320 can be provided for turning an audio device on or off and/or to adjust a volume of the audio device. In this example, the haptic device(s) 140 can be located within a steering wheel 330 of the vehicle.

In this example a user can adjust the volume of the audio device by manipulating the virtual button 320 with his or her right hand 350. When an input in provided on the virtual button 320, a signal can be sent to the processor(s) 110 and/or the displaced haptic feedback module(s) 170. Responsive to receiving the signal, the processor(s) 110 and/or the displaced haptic feedback module(s) 170 can cause the haptic device to be activated.

As a result, haptic feedback can be provided in the form of a vibration 360 of a portion of the steering wheel 330. The vibration can be felt by the left hand 370 of the driver. Thus, the driver can be apprised of the fact that his or her input on the touchscreen 310 has been received, performed, and/or the degree to which the input has been performed. It will be appreciated that the haptic feedback is displaced in that it is not provided on the touchscreen 310, the driver's right hand 350, and/or the finger engaging the touchscreen 310.

In some arrangements, the haptic feedback can be accompanied by an additional feedback, such as visual feedback, audial feedback, olfactory feedback, and/or additional haptic feedback. While the haptic feedback is shown in FIG. 3 as being in the form of a vibration, it will be appreciated that other forms of haptic feedback can be used, such as pressure, heating and/or cooling. Further, while the haptic feedback is shown in FIG. 3 as being provided by the steering wheel 330, it will be appreciated that the haptic feedback can be provided by other vehicle components 150, such as a portion of the driver's seat, armrest, or foot pedal, just to name a few possibilities.

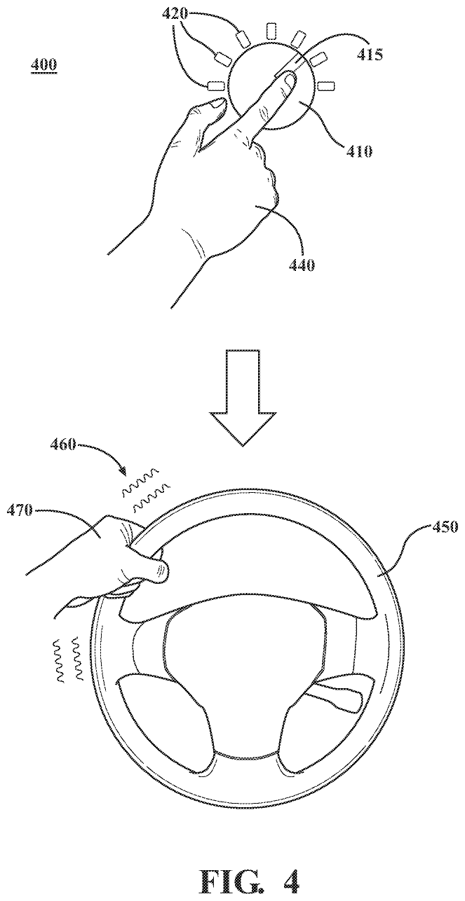

FIG. 4 is a second example of a displaced feedback scenario 400, which can be inside a vehicle cabin. Here, the user interface 130 can include a physical dial 410. In this example, the physical dial 410 can be provided for adjusting a volume of an audio device. The physical dial 410 can be moved, such as rotationally, by a user. Graduated volume marks 420 can be circumferentially arrayed about the physical dial 410 to indicate different volume levels. The physical dial 410 can include a selection indicator 415.

In this example, the haptic device(s) 140 can be located within a steering wheel 450 of the vehicle. In this example a user can adjust the volume of the audio device by manipulating the physical dial 410 with his or her right hand 440. As the selection indicator 415 passes one of the graduated volume marks 420, a signal can be sent to the processor(s) 110 and/or the displaced haptic feedback module(s) 170. Responsive to receiving the signal, the processor(s) 110 and/or the displaced haptic feedback module(s) 170 can cause the haptic device to be activated.

As a result, haptic feedback can be provided in the form of a vibration 460 of a portion of the steering wheel 450. The vibration can be felt by the left hand 470 of the driver. Thus, the driver can be apprised of the degree to which the input has been performed. It will be appreciated that the haptic feedback is displaced in the sense that it is not provided on the physical dial 410 and/or to the driver's right hand 440.

In this example, the vibrations can have a ‘detent’ pattern for adjusting a degree of a function, such as an audio volume, where the equivalent of passage over subsequent graduated volume marks 420 is accompanied by a haptic feedback as each individual graduated volume mark 240 is passed. In some cases, the degree of vibration can be proportionally increased or decreased. For example, as the user rotates the physical dial 410 clockwise in FIG. 4, corresponding to an increase in volume, the amount of vibration can increase. Likewise, as the user rotates the physical dial 410 counterclockwise in FIG. 4, corresponding to a decrease in volume, the amount of vibration can gradually decrease. In some instances, the amount of increase or decrease in vibration can be proportional to the increase or decrease in volume. The virtual turning of a dial can be accompanied by a haptic feedback detent pattern for an appreciation of the change in degree being input.

In some arrangements, the haptic feedback can be accompanied by an additional feedback, such as visual feedback, audial feedback, olfactory feedback, and/or additional haptic feedback. While the haptic feedback is shown in FIG. 4 as being in the form of a vibration, it will be appreciated that other forms of haptic feedback can be used, such as pressure, heating and/or cooling. Further, while the haptic feedback is shown in FIG. 4 as being provided by the steering wheel 450, it will be appreciated that the haptic feedback can be provided by other vehicle components 150, such as a portion of the driver's seat, armrest, or foot pedal, just to name a few possibilities. Still further, while the physical dial 410 in FIG. 4 is described as being for volume control, it will be appreciated that the physical dial 410 can be used to control other features, such as a heating function or a cooling function

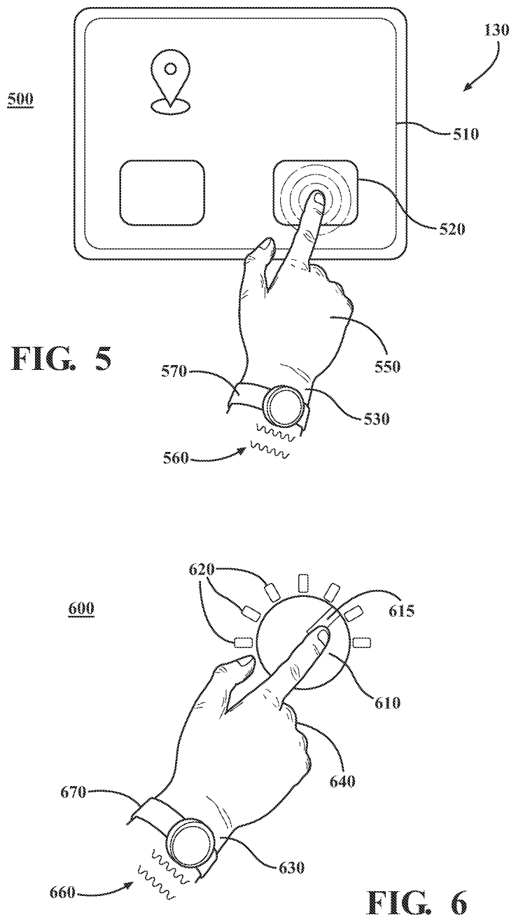

FIG. 5 is a third example of a displaced feedback scenario 500, which can be inside a vehicle cabin. Here, the user interface 130 can be a touchscreen 510 with a virtual button 520. In some cases, the touchscreen 510 can be located near the center of the vehicle's dashboard. The virtual button 520 can be provided for turning an audio device on or off and/or to adjust a volume of the audio device.

In this example, a haptic device can be located within a non-vehicle item, such as a watch 570 worn by the driver. The watch 570 can be operatively connected to the processor(s) 110 and/or the displaced haptic feedback module(s) 170. The watch 570 can be provided with the vehicle. The watch 570 can be a smart watch that includes application software (an app) to enable communication with the vehicle (e.g., the processor(s) 110 and/or the displaced haptic feedback module(s) 170). In some arrangements, a haptic device can be adhered, temporarily or permanently, to the watch 570 or other wearable device or handheld device (e.g., a phone) of the driver. In some instances, the haptic device can be provided with the vehicle.

In this example a user can adjust the volume of the audio device by manipulating the virtual button 520 with his or her right hand 550. When an input in provided on the virtual button 520, a signal can be sent to the processor(s) 110 and/or the displaced haptic feedback module(s) 170. Responsive to receiving the signal, the processor(s) 110 and/or the displaced haptic feedback module(s) 170 can cause the haptic device to be activated.

As a result, haptic feedback can be provided in the form of a vibration 560 of the watch 570. The vibration can be felt by the right wrist 530 of the driver. Thus, the driver can be apprised of the fact that his or her input on the touchscreen 510 has been received, performed, and/or the degree to which the input has been performed. It will be appreciated that the haptic feedback is displaced in that it is not provided on the touchscreen 510 and/or to the driver's right hand 550 or finger engaging the touchscreen 510.

In some arrangements, the haptic feedback can be accompanied by an additional feedback, such as visual feedback, audial feedback, olfactory feedback, and/or additional haptic feedback. While the haptic feedback is shown in FIG. 5 as being in the form of a vibration, it will be appreciated that other forms of haptic feedback can be used, such as pressure, heating and/or cooling. Further, while the haptic feedback is shown in FIG. 5 as being provided by the watch 570, it will be appreciated that the haptic feedback can be provided by vehicle components 150 or non-vehicle items 160.

FIG. 6 is a fourth example of a displaced feedback scenario 600, which can be inside a vehicle cabin. Here, the user interface 130 can include a physical dial 610. The above discussion with respect to the physical dial 410, the graduated volume marks 420, the selection indicator 415, and general discussion in FIG. 4 applies equally to the physical dial 610, the graduated volume marks 620, the selection indicator 615, and general discussion in FIG. 6.

In this example, a haptic device can be located within a non-vehicle item, such as a watch 670 worn by the driver. The above discussion with respect to the watch 570 in FIG. 5 applies equally to the watch 670 in FIG. 6.

Haptic feedback can be provided in the form of a vibration 660 of the watch 670. The vibration can be felt by the right wrist 630 of the driver. Thus, the driver can be apprised of the fact that his or her input on the physical dial 610 has been received, performed, and/or the degree to which the input has been performed. It will be appreciated that the haptic feedback is displaced in that it is not provided by the physical dial 610 and/or to the driver's right hand 640 or finger engaging the physical dial 610. The vibrations 660 can have a ‘detent’ pattern as described above in connection with FIG. 4.

It will be appreciated that arrangements described herein can provide numerous benefits, including one or more of the benefits mentioned herein. For example, arrangements described herein can allow a person to remain focused on a task while interfacing with a user interface. For instance, arrangements described herein can allow a vehicle driver to keep focused on driving while adjusting a non-driving control (e.g., environmental, entertainment, information, and/or other functions) within the vehicle. Arrangements described herein can provide assurance that a desired input was received without requiring the person to look at the user interface. The haptic feedback can provide assurance of successful receipt of the input on the user interface, implementation of the input, and/or the degree of implementation of an input provided on the user interface. Arrangements described herein can allow a user to know if an operation was properly performed without having to look at a user interface device. Arrangements described herein can allow the user to know if the touchscreen was properly interacted without having to look at the touchscreen in a manner similar to the mechanical (haptic) feedback the user receives from pressing a physical button or turning a physical dial.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied or embedded, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B and C” includes A only, B only, C only, or any combination thereof (e.g., AB, AC, BC or ABC).

As used herein, the term “substantially” or “about” includes exactly the term it modifies and slight variations therefrom. Thus, the term “substantially parallel” means exactly parallel and slight variations therefrom. “Slight variations therefrom” can include within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” or “about” can include being within normal manufacturing tolerances.

Aspects herein can be embodied in other forms without departing from the spirit or essential attributes thereof. Accordingly, reference should be made to the following claims, rather than to the foregoing specification, as indicating the scope of the invention.

1. A displaced haptic feedback system in a vehicle comprising:
a user interface including a touch interface or a gesture interface including at least one camera configured to capture a gesture made by a user, the user interface including a user interface element for adjusting a degree of a function, the user interface element including a plurality of graduated marks arrayed about at least a portion of a dial, the dial being one of a virtual dial or a physical dial, each of the plurality of graduated marks corresponding to different levels of the function; and
a processor operatively connected to the user interface, the processor being configured to:
receive an input signal from the user interface; and
responsive to receiving the input signal, causing a haptic device to be activated, the haptic device being physically separated from the user interface, the haptic device residing on or within a portion of a vehicle component or a non-vehicle item worn, attached to, or carried by a user, whereby the haptic device provides a haptic feedback including at least a vibration to the user interacting with the user interface,
the haptic feedback including a detent pattern when adjusting the degree of the function by the user interface element such that, as a user input provided on the user interface element passes each graduated mark, the haptic feedback is provided, the user input corresponding to an increase or a decrease in the function such that a proportional increase or decrease in the haptic feedback is provided at each graduated mark, whereby a different level of vibration is provided at each graduated mark by increasing or decreasing an amount of vibration, no haptic feedback being provided between graduated marks.

2. (canceled)

3. The displaced haptic feedback system according to claim 1, wherein the touch interface includes a touchscreen, a slider, a dial, or a joystick.

4-5. (canceled)

6. The displaced haptic feedback system according to claim 1, wherein the vehicle component is a steering wheel, a seat, a seat back, an arm rest. a head rest, a footrest, or a pedal.

7. (canceled)

8. The displaced haptic feedback system according to claim 1, wherein the non-vehicle item includes a portion of a watch, a bracelet, a necklace, a headband, a hat, a pocket, clothing, or a wallet.

9. The displaced haptic feedback system according to claim 1, wherein the haptic feedback further includes a pressure, a heating sensation, a cooling sensation, or any combination thereof.

10. (canceled)

11. The displaced haptic feedback system according to claim 1, wherein the user interface is for control of at least one of an environmental, entertainment, information component of a vehicle.

12. A displaced haptic feedback method comprising:
receiving an input signal from a user interface including a touch interface or a gesture interface including at least one camera configured to capture a gesture made by a user, the user interface including a user interface element for adjusting a degree of a function, the user interface element including a plurality of graduated marks arrayed about at least a portion of a dial, the dial being one of a virtual dial or a physical dial, each of the plurality of graduated marks corresponding to different levels of the function; and
responsive to receiving the input signal, causing a haptic device to be activated, the haptic device being physically separated from the user interface, the haptic device residing on or within a portion of a vehicle component or a non-vehicle item worn, attached to, or carried by a user, whereby the haptic device provides a haptic feedback including at least a vibration to the user interacting with the user interface,
the haptic feedback including a detent pattern when adjusting the degree of the function by the user interface element such that, as a user input provided on the user interface element passes each graduated mark, the haptic feedback is provided, the user input corresponding to an increase or a decrease in the function such that a proportional increase or decrease in the haptic feedback is provided at each graduated mark, whereby a different level of vibration is provided at each graduated mark by increasing or decreasing an amount of vibration, no haptic feedback being provided between graduated marks.

13. (canceled)

14. The displaced haptic feedback method according to claim 12, wherein the touch interface includes a touchscreen, a slider, a dial, or a joystick.

15. (canceled)

16. The displaced haptic feedback method according to claim 12, wherein the haptic feedback further includes a pressure, a heating sensation, a cooling sensation, or any combination thereof.

17. (canceled)

18. The displaced haptic feedback method according to claim 12, wherein the vehicle component includes a steering wheel, a seat, a seat back, an arm rest, a head rest, a footrest, or a pedal.

19. (canceled)

20. The displaced haptic feedback method according to claim 12, wherein the non-vehicle item includes a watch, a bracelet, a necklace, a headband, a hat, a pocket, an article of clothing, or a wallet.

21. (canceled)

22. The displaced haptic feedback system according to claim 1, wherein the haptic feedback further includes a heating sensation or a cooling sensation.
